(19) United States
(12) Patent Application Publication
(10) Pub. No.: US 2025/0087000 A1
(43) Pub. Date: Mar. 13, 2025

(54) CHARACTER RECOGNITION APPARATUS FOR RECOGNIZING CHARACTER STRING OVER MULTIPLE LINES NOT HAVING KNOWN FORMAT

(71) Applicant: Panasonic Intellectual Property Management Co., Ltd., Osaka (JP)

(72) Inventors: Riku MATSUMOTO, Hyogo (JP); Ken HATSUDA, Kyoto (JP); Masamitsu MURASE, Kyoto (JP)

(21) Appl. No.: 18/955,050

(22) Filed: Nov. 21, 2024

Related U.S. Application Data
(63) Continuation of application No. PCT/JP2023/043304, filed on Dec. 4, 2023.

(30) Foreign Application Priority Data
Feb. 20, 2023 (JP) 2023-024524

(51) Int. Cl. G06V 30/14

(52) U.S. Cl. CPC G06V 30/1452

(57) ABSTRACT

The computing circuit detects a plurality of character regions in the input image, each of the plurality of character regions including a character or a character string made of a plurality of characters. The computing circuit determines a direction of the character or the character string in each of the character regions. The computing circuit recognizes the character or the character string in each of the character regions. The computing circuit generates a connected region by connecting at least two character regions including the character(s) or the character string(s) having a same direction, the at least two character regions being close to each other at a distance less than a threshold. The computing circuit connects the character(s) or the character string(s) included in the connected region to each other.

This is a continuation application of International Application No. PCT/JP2023/043304, with an international filing date of Dec. 4, 2023, which claims priority of Japanese patent application No. 2023-024524 filed on Feb. 20, 2023, the contents of which are incorporated herein by reference.

### BACKGROUND

### 1. Technical Field

The present disclosure relates to a character recognition apparatus, a character recognition method, and a program.

### 2. Description of Related Art

When a computer automatically recognizes character strings in an image, a target character string does not necessarily have a known format. For example, due to a limitation in size of a label or the like on which a character string is printed, the character string may be broken at the middle and printed over multiple lines.

For example, Japanese Patent No. JP3673034B discloses a mail processing apparatus, in particular, a mail address region detection apparatus used to read addresses of mails and classify the mails according to their destinations. The apparatus of JP3673034B detects an address region candidate by combining adjacent lines among detected lines, compares sizes and relative positions of lines in the address region candidate with a predefined evaluation criterion stored in a database, and selects a line of high similarity or evaluation in the address region candidate as an address start line candidate.

### SUMMARY

The apparatus of JP3673034B processes mail addresses with a known format stored in the database, but it is difficult to process a character string without a known format, such as a character string printed on a label of an object included in an any captured image, for example. Therefore, it is required to recognize a character string over multiple lines not having a known format, without the need to refer to a format database.

One non-limiting and exemplary embodiment provides a character recognition apparatus, a character recognition method, and a program, capable of recognizing a character string over multiple lines not having a known format.

According to one aspect of the present disclosure, a character recognition apparatus is provided for processing an input image to recognize characters included in the input image. The character recognition apparatus is provided with: a computing circuit; and a memory that stores instructions being executable by the computing circuit. When executing the instructions, the computing circuit detects a plurality of character regions in the input image, each of the plurality of character regions including a character or a character string made of a plurality of characters. When executing the instructions, the computing circuit determines a direction of the character or the character string in each of the character regions. When executing the instructions, the computing circuit recognizes the character or the character string in each of the character regions. When executing the instructions, the computing circuit generates a connected region by connecting at least two character regions including the character(s) or the character string(s) having a same direction, the at least two character regions being close to each other at a distance less than a threshold. When executing the instructions, the computing circuit connects the character(s) or the character string(s) included in the connected region to each other. When executing the instructions, the computing circuit detects a first object region and a second object region in the input image, the first object region including a first object, and the second object region including a second object. When executing the instructions, the computing circuit detects a first character region or a first connected region included in the first object region, and detects a second character region or a second connected region included in the second object region. When executing the instructions, the computing circuit recognizes a first character or character string included in the first character region or the first connected region, and recognizes a second character or character string included in the second character region or the second connected region. When executing the instructions, the computing circuit compares the first character or character string with a third character or character string stored in advance in association with the first object, and compares the second character or character string with a fourth character or character string stored in advance in association with the second object.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

According to the character recognition apparatus according to one aspect of the present disclosure, it is possible to recognize a character string over multiple lines not having a known format.

### BRIEF DESCRIPTION OF DRAWINGS

FIG. 1 is a block diagram showing a configuration of a character recognition apparatus 1 according to a first embodiment;

FIG. 2 is a flowchart showing character recognition process executed by a CPU 11 of FIG. 1;

FIG. 3 is a diagram showing an example of an input image 20 captured by an image capturing device 14 of FIG. 1;

FIG. 4 is a diagram showing an example of object regions detected in step S2 of FIG. 2;

FIG. 5 is a diagram showing an example of character regions detected in step S3 of FIG. 2;

FIG. 6 is a diagram for illustrating a first algorithm for connecting character regions in step S6 of FIG. 2;

FIG. 7 is a diagram for illustrating a second algorithm for connecting character regions in step S6 of FIG. 2;

FIG. 8 is a diagram showing an example of character regions connected in step S6 of FIG. 2;

FIG. 9 is a diagram showing an example of terminal character strings and cable character strings to be associated with each other in step S8 of FIG. 2;

FIG. 10 is a diagram showing an example of matching of character strings to be determined in step S8 of FIG. 2;

FIG. 11 is a diagram showing another example of matching of character strings to be determined in step S8 of FIG. 2;

FIG. 12 is a diagram showing another example of character regions detected in step S3 of FIG. 2;

FIG. 13 is a diagram for illustrating an algorithm for connecting the character regions of FIG. 12;

FIG. 14 is a diagram showing an example of connected character regions of the character regions of FIG. 12; and

FIG. 15 is a block diagram showing a configuration of a character recognition system 100 according to a second embodiment.

### DETAILED DESCRIPTION

Hereinafter, embodiments will be described in detail with reference to the drawings as appropriate. However, excessively detailed explanation may be omitted. For example, detailed explanation of well-known matters may be omitted, and redundant explanations on substantially the same configuration may be omitted. This is to avoid the unnecessary redundancy of the following description, and to facilitate understanding by those skilled in the art.

It is to be noted that the inventor(s) intends to provide the accompanying drawings and the following description so that those skilled in the art can sufficiently understand the present disclosure, and does not intend to limit subject matters recited in the claims.

### First Embodiment

A character recognition apparatus according to a first embodiment is configured as an integrated computer, such as a tablet computer, provided with: an image capturing device, an input device, and a display device.

### Configuration of First Embodiment

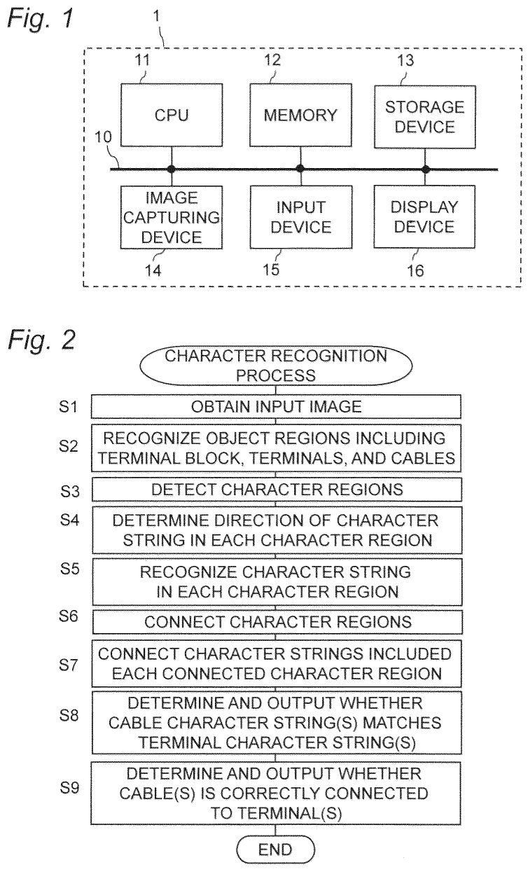

FIG. 1 is a block diagram showing a configuration of a character recognition apparatus 1 according to the first embodiment. The character recognition apparatus 1 is provided with a bus 10, a central processing unit (CPU) 11, a memory 12, a storage device 13, an image capturing device 14, an input device 15, and a display device 16. The CPU 11 controls overall operations of the character recognition apparatus 1, and executes character recognition process described below with reference to FIG. 2 to process an input image captured by the image capturing device 14 to recognize characters included in the input image. The memory 12 temporarily stores programs and data necessary to the operations of the character recognition apparatus 1. The storage device 13 is a non-volatile storage medium that stores programs and data necessary to the operations of the character recognition apparatus 1. The image capturing device 14 captures an object to generate an input image. The image capturing device 14 is, for example, an RGB camera. The input device 15 receives a user's inputs for controlling the operations of the character recognition apparatus 1. The input device 15 includes, for example, a keyboard and/or a pointing device. The display device 16 displays an input image, recognized characters, and the like. The CPU 11, the memory 12, the storage device 13, the image capturing device 14, the input device 15, and the display device 16 are connected to each other through a bus 10.

The input device 15 may be, for example, a touch panel device integrated with the display device 16, and it may be operated by a user's fingers or a stylus.

The CPU 11 is an example of a computing circuit. In addition, the programs stored in the memory 12 and the storage device 13 are examples of instructions executable by the CPU 11.

In the embodiments of the present disclosure, we will describe, for example, a case of recognizing character strings printed on a terminal block of a distribution board, and character strings printed on cables connected to the distribution board.

In the present disclosure, the term “character” indicates alphabet, number, hiragana, katakana, kanji, and symbol (such as punctuation). In addition, in the present disclosure, the term “character string” indicates a plurality of characters consecutively arranged.

### Operations of First Embodiment

FIG. 2 is a flowchart showing character recognition process executed by the CPU 11 of FIG. 1.

In step S1, the CPU 11 obtains the input image captured by the image capturing device 14.

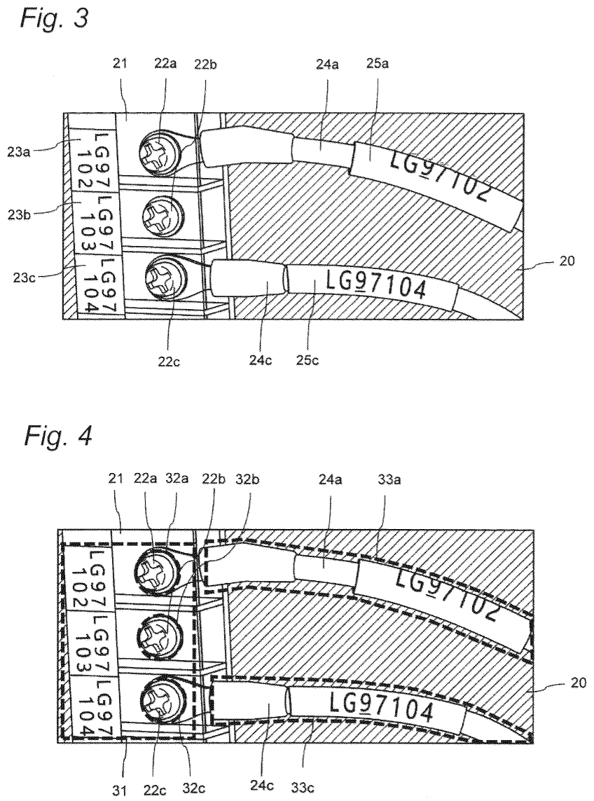

FIG. 3 is a diagram showing an example of an input image 20 captured by the image capturing device 14 of FIG. 1. The input image 20 includes: a terminal block 21 including terminals 22a to 22c; labels 23a to 23c respectively attached near the terminals 22a to 22c; cables 24a and 24c respectively connected to the terminals 22a and 22c; and labels 25a and 25c respectively attached to the cables 24a and 24c. In the embodiments of the present disclosure, we will describe a case of recognizing character strings printed on the labels 23a to 23c, 25a, and 25c. A character string of each of the labels 23a to 23c is broken at the middle and printed over two lines, due to a limitation in size of the labels 23a to 23c.

In step S2 of FIG. 2, the CPU 11 recognizes object regions in the input image 20, the object regions including the terminal block 21, the terminals 22a to 22c, and the cables 24a and 24c, respectively.

FIG. 4 is a diagram showing an example of object regions detected in step S2 of FIG. 2. In the example of FIG. 4, the CPU 11 recognizes the object region 31 including the terminal block 21, the object regions 32a to 32c respectively including the terminals 22a to 22c, and the object regions 33a and 33c respectively including the cables 24a and 24c.

The CPU 11 may automatically recognize the object regions using a well-known technique, for example, the technique disclosed in Kaiming He et al., “Mask R-CNN” (https://arxiv.org/pdf/1703.06870.pdf), or may recognize the object regions based on the user's inputs obtained through the input device 15 (in a manual manner).

In step S3 of FIG. 2, the CPU 11 detects character regions in the input image 20, each of the character regions including a character or a character string made of a plurality of characters.

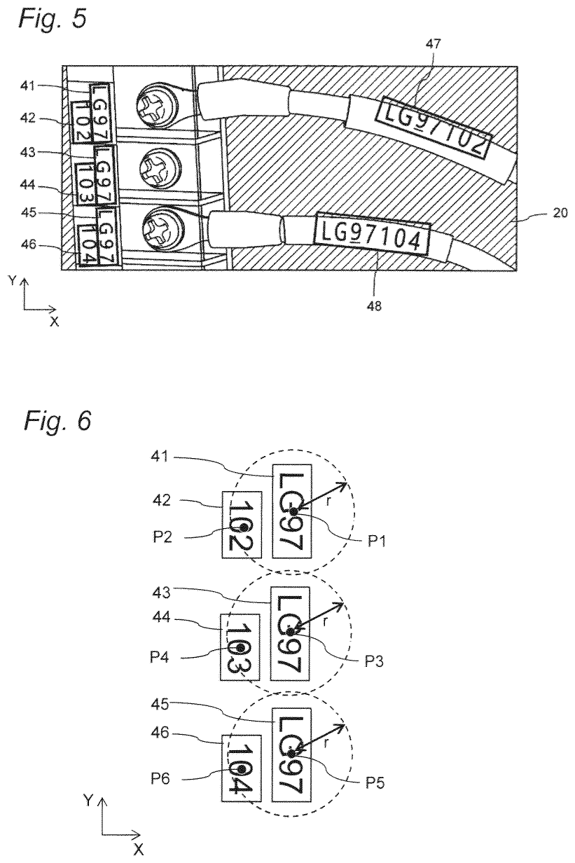

FIG. 5 is a diagram showing an example of character regions detected in step S3 of FIG. 2. The character regions 41 and 42 include character strings printed on the label 23a. The character regions 43 and 44 include character strings printed on the label 23b. The character regions 45 and 46 include character strings printed on the label 23c. The character region 47 includes a character string printed on the label 25a. The character region 48 includes a character string printed on the label 25c.

The CPU 11 may automatically detect the character regions using a well-known technique, for example, a technique disclosed in Minghui Liao, “Real-time Scene Text Detection with Differentiable Binarization” (https://arxiv.org/abs/1911.08947).

In step S4 of FIG. 2, the CPU 11 determines a direction of the character or the character string in each character region. For example, the CPU 11 may determine an angle closest to the direction of the character or the character string, among 0 degrees, 90 degrees, 180 degrees, and 270 degrees with respect to the X direction in FIG. 5, as the direction of the character or the character string. In the example of FIG. 5, it is determined that the character strings in the character regions 41 to 46 are arranged substantially in the Y direction, and the character strings in the character regions 47 and 48 are arranged substantially in the X direction. The CPU 11 may automatically determine the direction of the character or the character string using a well-known technique, or may determine the direction of the character or the character string based on the user's inputs obtained through the input device 15 (in a manual manner).

In step S5, the CPU 11 recognizes the character or the character string in each character region. The CPU 11 may recognize the characters or the character strings using a well-known technique, for example, the technique disclosed in Baoguang Shi et al., “An End-to-End Trainable Neural Network for Image-based Sequence Recognition and Its Application to Scene Text Recognition” (https://arxiv.org/pdf/1507.05717). In the example of FIG. 5, the character strings in the character regions 41 to 48 are recognized as “LG97”, “102”, “LG97”, “103”, “LG97”, “104”, “LG97102”, and “LG97104”, respectively.

In step S6, the CPU 11 connects the character regions each including a part of the character string broken into multiple lines.

FIG. 6 is a diagram for illustrating a first algorithm for connecting character regions in step S6 of FIG. 2. The character regions 41 and 42 include character strings having the same direction, and are close to each other with a distance less than a threshold “r”. The distance between the character regions 41 and 42 is defined as, for example, a distance between the centers P1 and P2 of the character regions 41 and 42. The character regions 43 and 44 include character strings having the same direction, and are close to each other with a distance less than the threshold “r”. The distance between the character regions 43 and 44 is defined as, for example, a distance between the centers P3 and P4 of the character regions 43 and 44. The character regions 45 and 46 include character strings having the same direction, and are close to each other with a distance less than the threshold “r”. The distance between the character regions 45 and 46 is defined as, for example, a distance between the centers P5 and P6 of the character regions 45 and 46. When the character regions 41 to 46 satisfy the above-mentioned conditions, the CPU 11 may connect the character regions 41 and 42 to each other, connect the character regions 43 and 44 to each other, and connect the character regions 45 and 46 to each other.

The threshold “r” may be individually determined for each character region, for example, as a product of a height “h” of the character region (that is, the length in the X direction in FIG. 6) and a predetermined coefficient “k”. Accordingly, it is possible to connect the character regions without depending on the relative sizes of the character regions in the input image 20.

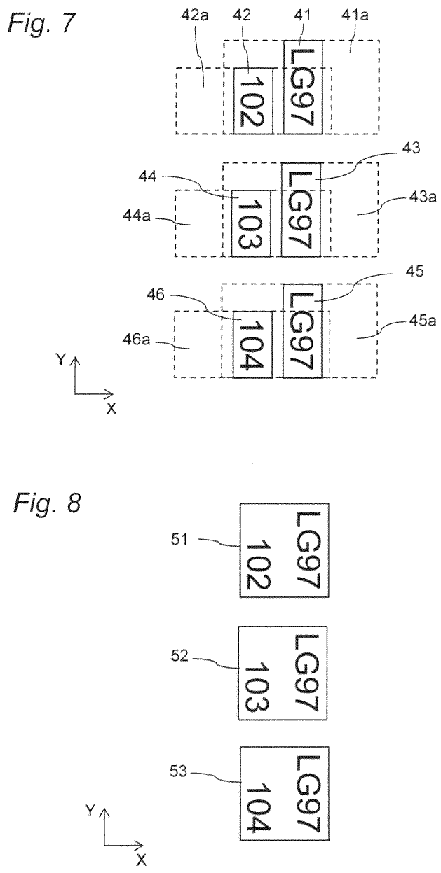

FIG. 7 is a diagram for illustrating a second algorithm for connecting character regions in step S6 of FIG. 2. The CPU 11 generates extended regions 41a to 46a by extending each of the character regions 41 to 46, by a predetermined distance, in a direction (X direction) perpendicular to the direction of the character string included in the character region. The character regions 41 and 42 include character strings having the same direction, and have extended regions 41a and 42a overlapping each other, respectively. The character regions 43 and 44 include character strings having the same direction, and have extended regions 43a and 44a overlapping each other, respectively. The character regions 45 and 46 include character strings having the same direction, and have extended regions 45a and 46a overlapping each other, respectively. When the character regions 41 to 46 satisfy the above-mentioned conditions, the CPU 11 may connect the character regions 41 and 42 to each other, connect the character regions 43 and 44 to each other, and connect the character regions 45 and 46 to each other.

The CPU 11 may use the algorithm of FIG. 6 and the algorithm of FIG. 7 individually or in combination.

FIG. 8 is a diagram showing an example of character regions connected in step S6 of FIG. 2. When the character regions 41 to 46 satisfy the conditions of FIG. 6 and/or the conditions of FIG. 7, the CPU 11 generates a connected region 51 by connecting the character regions 41 and 42 to each other, generates a connected region 52 by connecting the character regions 43 and 44 to each other, and generates a connected region 53, by connecting the character regions 45 and 46 to each other.

In step S7, the CPU 11 connects the character(s) or the character string(s) included in each of the connected character regions, to each other. In the example of FIG. 8, the character strings “LG97” and “102” included in the connected region 51 are connected to generate a character string “LG97102”, the character strings “LG97” and “103” included in the connected region 52 are connected to generate a character string “LG97103”, and the character strings “LG97” and “104” included in the connected region 53 are connected to generate a character string “LG97104”.

In step S8, the CPU 11 determines whether or not the character string(s) of the cable(s) matches the character string(s) of the terminal(s), and outputs the results to the display device 16.

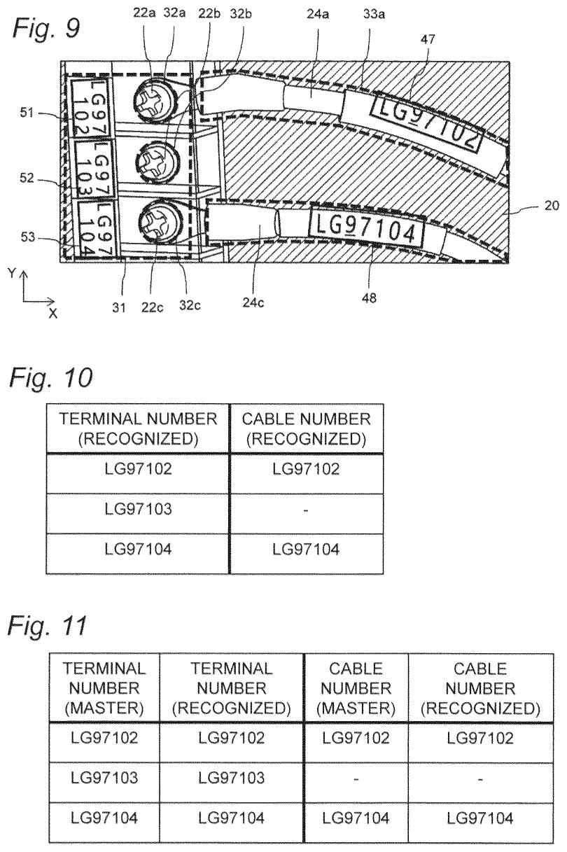

FIG. 9 is a diagram showing an example of terminal character strings and cable character strings to be associated with each other in step S8 of FIG. 2. The connected regions 51 to 53 are included in the object region 31 of the terminal block 21, and are positioned near the object regions 32a to 32c of the terminals 22a to 22c, respectively. In addition, the character regions 47 and 48 are included in the object regions 33a and 33c of the cables 24a and 24c, respectively. Accordingly, it can be seen that the character strings “LG97102”, “LG97103”, and “LG97104” included in the connected regions 51 to 53 indicate the terminals 22a to 22c, respectively, and the character strings “LG97102” and “LG97104” included in the character regions 47 and 48 indicate the cables 24a and 24c, respectively.

Since one end of the object region 33a of the cable 24a is near the object region 32a of the terminal 22a as shown in the example of FIG. 9, the CPU 11 may determine that the cable 24a is connected to the terminal 22a. In addition, since one end of the object region 33c of the cable 24c is near the object region 32c of the terminal 22c, the CPU 11 may determine that the cable 24c is connected to the terminal 22c. Then, the CPU 11 may compare the character strings “LG97102” and “LG97104” indicating the cables 24a and 24c (i.e., cable numbers), with the character strings “LG97102”, “LG97103”, and “LG97104” indicating the terminals 22a to 22c (i.e., terminal numbers).

FIG. 10 is a diagram showing an example of matching of character strings to be determined in step S8 of FIG. 2. With respect to the recognized terminal numbers “LG97102” and “LG97104”, the corresponding recognized cable numbers “LG97102” and “LG97104” exist. On the other hand, with respect to the recognized terminal number “LG97103”, a corresponding recognized cable number does not exist. Therefore, it can be seen that the cables having the cable numbers “LG97102” and “LG97104” are connected to the terminals having the terminal numbers “LG97102” and “LG97104”.

FIG. 11 is a diagram showing another example of matching of character strings to be determined in step S8 of FIG. 2. When terminal numbers and cable numbers of available terminals and available cables are known and stored as master data, e.g., in the storage device 13, the CPU 11 may compare recognized terminal numbers and recognized cable numbers, with the terminal numbers and the cable numbers of the master data. In the example of FIG. 11, although the terminal number “LG97103” of the master data exists, the corresponding cable number of the master data does not exist. In addition, in the example of FIG. 11, with respect to the recognized terminal number “LG97103”, the corresponding recognized cable number does not exist as in the example of FIG. 10. Therefore, a terminal number of the master data matching the recognized terminal number “LG97103” exists. By comparing the recognized results with the master data, it can be determined to be normal that any cable is not connected to the terminal having the terminal number “LG97103”. Accordingly, it is possible to more accurately understand the status of connections of the terminals and the cables, than without the master data.

The CPU 11 determines whether or not the cable character string matches the terminal character string, and outputs the results to the display device 16 in the format of FIG. 10 or FIG. 11, or in any other format.

In step S9 of FIG. 2, the CPU 11 determines whether or not the cable(s) is correctly connected to the terminal(s), based on whether or not the cable character string(s) matches the terminal character string(s), and outputs the results to the display device 16. When terminal numbers and cable numbers of available terminals and available cables are known and stored as master data, e.g., in the storage device 13 (see FIG. 11), the CPU 11 may determine whether or not the cable(s) is correctly connected to the terminal(s), based on whether or not the recognized number(s) matches the corresponding number(s) of the master data, and output the results to the display device 16.

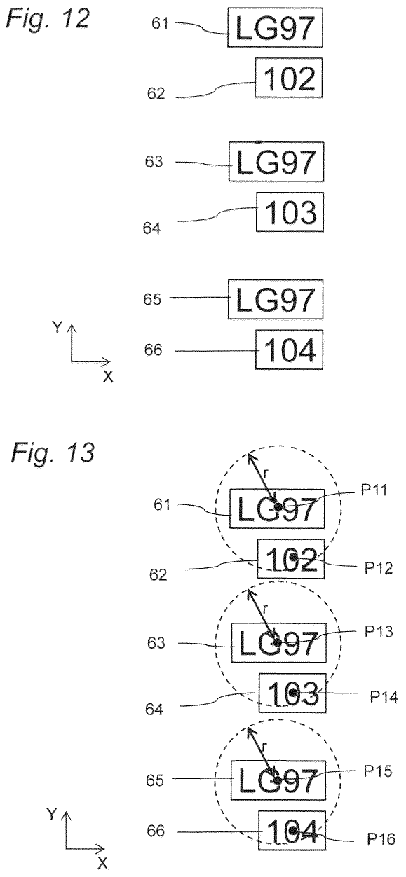

In the example of FIG. 2 and others, we have described the case where the direction of the character strings of the labels 23a to 23c is parallel to the straight line passing through the terminals 22a to 22c. On the other hand, the character recognition process according to the embodiment is also applicable to a case where the direction of the character strings of the labels 23a to 23c is perpendicular to the straight line passing through the terminals 22a to 22c. Hereinafter, we will describe the latter case with reference to FIGS. 12 to 14.

FIG. 12 is a diagram showing another example of character regions detected in step S3 of FIG. 2. Character regions 61 and 62 include character strings printed on a first label. Character regions 63 and 64 include character strings printed on a second label. Character regions 65 and 66 include character strings printed on a third label. In the example of FIG. 12, the character strings 61 to 66 are arranged in the X direction.

FIG. 13 is a diagram for illustrating an algorithm for connecting the character regions of FIG. 12. The example of FIG. 13 shows the case of applying the algorithm of FIG. 6 to the character regions 61 to 66 of FIG. 12. The character regions 61 and 62 include character strings having the same direction, and are close to each other with a distance less than the threshold “r”. The distance between the character regions 61 and 62 is defined as, for example, a distance between the centers P11 and P12 of the character regions 61 and 62. The character regions 63 and 64 include character strings having the same direction, and are close to each other with a distance less than the threshold “r”. The distance between the character regions 63 and 64 is defined as, for example, a distance between the centers P13 and P14 of the character regions 63 and 64. The character regions 65 and 66 include character strings having the same direction, and are close to each other with a distance less than the threshold “r”. The distance between the character regions 65 and 66 is defined as, for example, a distance between the centers P15 and P16 of the character regions 65 and 66. When the character regions 61 to 66 satisfy the above-mentioned conditions, the CPU 11 may connect the character regions 61 and 62 to each other, connect the character regions 63 and 64 to each other, and connect the character regions 65 and 66 to each other.

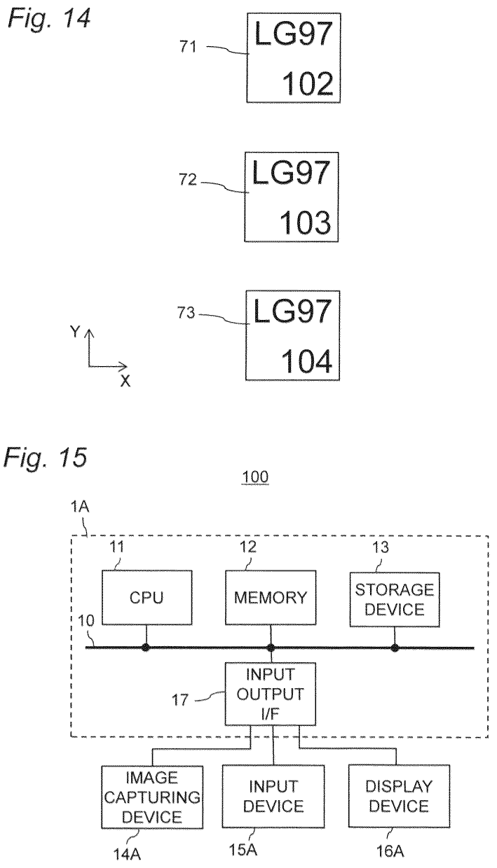

FIG. 14 is a diagram showing an example of connected character regions of the character regions of FIG. 12. When the character regions 61 to 66 satisfy the conditions of FIG. 6 and/or the conditions of FIG. 7, the CPU 11 generates a connected region 71 by connecting the character regions 61 and 62 to each other, generates a connected region 72 by connecting the character regions 63 and 64 to each other, and generates a connected region 73 by connecting the character regions 65 and 66 to each other.

According to the example of FIGS. 12 to 14, it can be seen that the algorithm of FIG. 6 is applicable regardless of the direction of the character strings.

As described above, the character recognition apparatus 1 according to the embodiment can connect the character regions each including a part of the character string broken into multiple lines, by using the algorithm of FIG. 6 and/or the algorithm of FIG. 7. Conventionally, it has been difficult to correctly recognize a character string having a line break(s) at any position(s) and not having a known format. On the other hand, the character recognition apparatus 1 according to the embodiment can connect character regions, and thus, recognize a character string over multiple lines not having a known format.

The character recognition apparatus 1 according to the embodiment can determine whether or not the cable(s) is correctly connected to the terminal(s), based on whether or not the cable character string(s) matches the terminal character string(s).

In the example of FIG. 2 and others, we have described the case where the label character strings are printed over multiple lines. The character recognition process according to the embodiment is also applicable to a case where the cable character string(s) is printed over multiple lines.

The character recognition apparatus 1 may recognize character strings printed on terminals of a distribution board, and character strings printed on cables connected to the distribution board. In this case, the character recognition apparatus 1 may match the terminal character string(s) with the cable character string(s). Accordingly, one operator can easily determine whether or not the cable(s) is correctly connected to the terminal(s), only by using the character recognition apparatus 1 to capture the distribution board.

### Advantageous Effects of First Embodiment

According to one aspect of the present disclosure, a character recognition apparatus 1 is provided for processing an input image to recognize characters included in the input image. The character recognition apparatus 1 is provided with: a CPU 11; and a memory that stores instructions being executable by the CPU 11. When executing the instructions, the CPU 11 detects a plurality of character regions in the input image, each of the plurality of character regions including a character or a character string made of a plurality of characters. When executing the instructions, the CPU 11 determines a direction of the character or the character string in each of the character regions. When executing the instructions, the CPU 11 recognizes the character or the character string in each of the character regions. When executing the instructions, the CPU 11 generates a connected region by connecting at least two character regions including the character(s) or the character string(s) having a same direction, the at least two character regions being close to each other at a distance less than a threshold. When executing the instructions, the CPU 11 connects the character(s) or the character string(s) included in the connected region to each other.

With such configuration, it is possible to connect character regions, and thus, recognize a character string over multiple lines not having a known format.

According to one aspect of the present disclosure, the character recognition apparatus 1 may be configured as follows. When executing the instructions, the CPU 11 generates extended regions by extending each of the character regions in a direction perpendicular to the direction of the character or the character string included in the character region. When executing the instructions, the CPU 11 generates the connected region by connecting at least two character regions including the character(s) or the character string(s) having the same direction, the at least two character regions being close to each other at the distance less than the threshold, and the at least two character regions having the extended regions overlapping each other, respectively.

With such configuration, it is possible to connect character regions, and thus, recognize a character string over multiple lines not having a known format.

According to one aspect of the present disclosure, the character recognition apparatus 1 may be configured as follows. When executing the instructions, the CPU 11 detects a first object region and a second object region in the input image, the first object region including a first object, and the second object region including a second object. When executing the instructions, the CPU 11 detects a first character region or a first connected region included in the first object region, and detects a second character region or a second connected region included in the second object region. When executing the instructions, the CPU 11 recognizes a first character or character string included in the first character region or the first connected region, and recognizes a second character or character string included in the second character region or the second connected region. When executing the instructions, the CPU 11 compares the first character or character string with a third character or character string stored in advance in association with the first object, and compares the second character or character string with a fourth character or character string stored in advance in association with the second object.

With such configuration, it is possible to determine whether or not the first object is correctly arranged with respect to the second object.

According to one aspect of the present disclosure, a character recognition method is provided for processing an input image to recognize characters included in the input image. The character recognition method includes detecting a plurality of character regions in the input image, each of the plurality of character regions including a character or a character string made of a plurality of characters. The character recognition method includes determining a direction of the character or the character string in each of the character regions. The character recognition method includes recognizing the character or the character string in each of the character regions. The character recognition method includes generating a connected region by connecting at least two character regions including the character(s) or the character string(s) having a same direction, the at least two character regions being close to each other at a distance less than a threshold. The character recognition method includes connecting the character(s) or the character string(s) included in the connected region to each other.

With such configuration, it is possible to connect character regions, and thus, recognize a character string over multiple lines not having a known format.

According to one aspect of the present disclosure, the character recognition method may be configured as follows. The character recognition method includes detecting a first object region and a second object region in the input image, the first object region including a first object, and the second object region including a second object. The character recognition method includes detecting a first character region or a first connected region included in the first object region, and detecting a second character region or a second connected region included in the second object region. The character recognition method includes recognizing a first character or character string included in the first character region or the first connected region, and recognizing a second character or character string included in the second character region or the second connected region. The character recognition method includes comparing the first character or character string with a third character or character string stored in advance in association with the first object, and comparing the second character or character string with a fourth character or character string stored in advance in association with the second object.

With such configuration, it is possible to determine whether or not the first object is correctly arranged with respect to the second object.

According to one aspect of the present disclosure, a program is provided, including instructions executed by a CPU 11 implemented in a character recognition apparatus 1 for processing an input image to recognize characters included in the input image. The instructions cause the CPU 11 to execute detecting a plurality of character regions in the input image, each of the plurality of character regions including a character or a character string made of a plurality of characters. The instructions cause the CPU 11 to execute determining a direction of the character or the character string in each of the character regions. The instructions cause the CPU 11 to execute recognizing the character or the character string in each of the character regions. The instructions cause the CPU 11 to execute generating a connected region by connecting at least two character regions including the character(s) or the character string(s) having a same direction, the at least two character regions being close to each other at a distance less than a threshold. The instructions cause the CPU 11 to execute connecting the character(s) or the character string(s) included in the connected region to each other.

With such configuration, it is possible to connect character regions, and thus, recognize a character string over multiple lines not having a known format.

According to one aspect of the present disclosure, the program may be configured as follows. The instructions cause the CPU 11 to execute: detecting a first object region and a second object region in the input image, the first object region including a first object, and the second object region including a second object. The instructions cause the CPU 11 to execute detecting a first character region or a first connected region included in the first object region, and detecting a second character region or a second connected region included in the second object region. The instructions cause the CPU 11 to execute recognizing a first character or character string included in the first character region or the first connected region, and recognizing a second character or character string included in the second character region or the second connected region. The instructions cause the CPU 11 to execute comparing the first character or character string with a third character or character string stored in advance in association with the first object, and comparing the second character or character string with a fourth character or character string stored in advance in association with the second object.

With such configuration, it is possible to determine whether or not the first object is correctly arranged with respect to the second object.

### Second Embodiment

In the first embodiment, we have described the case where the character recognition apparatus is configured as an integrated computer, provided with the image capturing device, the input device, and the display device. However, the image capturing device, the input device, and the display device may be provided separately from the character recognition apparatus.

FIG. 15 is a block diagram showing a configuration of a character recognition system 100 according to the second embodiment. The character recognition system 100 of FIG. 15 includes a character recognition apparatus 1A, an image capturing device 14A, an input device 15A, and a display device 16A. The character recognition apparatus 1A is, for example, a desktop computer, and is provided with: a bus 10, a CPU 11, a memory 12, a storage device 13, and an input/output interface (I/F) 17. The bus 10, the CPU 11, the memory 12, and the storage device 13 of FIG. 15 are configured in a manner similar to that of the corresponding components of FIG. 1. The input/output interface (I/F) 17 is connected to the image capturing device 14A, the input device 15A, and the display device 16A. The image capturing device 14A, the input device 15A, and the display device 16A are configured in a manner similar to that of the image capturing device 14, the input device 15, and the display device 16 of FIG. 1.

The character recognition system 100 of FIG. 15 can also connect character regions, and thus, recognize a character string over multiple lines not having a known format, in a manner similar to that of the character recognition apparatus 1 of FIG. 1.

### Other Embodiments

As described above, the embodiments have been described as examples of the technology disclosed in the present application. However, the technology of the present disclosure is not limited thereto, and can be applied to embodiments with some change, replacement, addition, omission, and the like. In addition, new embodiments can be derived by combining the components described in the aforementioned embodiment. Thus, other embodiments will be exemplified below.

In the examples of FIGS. 5, 12, and others, we have described the case where each character region includes a character string including a plurality of characters. However, the character recognition process according to the embodiment can be similarly applied to a case where a character region includes only one character. Accordingly, the character region including one character is connected to another character region including a character or a character string made of a plurality of characters.

The character recognition apparatus 1 of FIG. 1 and the character recognition apparatus 1A of FIG. 15 may be configured to be connected to a separate apparatus through a communication line, and transmit recognized characters to the separate apparatus.

Accordingly, the constituent elements described in the accompanying drawings and the detailed description may include not only constituent elements essential to solving the problem, but also constituent elements not essential to solving the problem, in order to exemplify the technique. Therefore, even when those non-essential constituent elements are described in the accompanying drawings and the detailed description, those non-essential constituent elements should not be considered essentials.

In addition, since the above-described embodiments are intended to exemplify the technique of the present disclosure, it is possible to make various changes, replacements, additions, omissions, and the like within the scope of claims or the equivalent thereof.

### SUMMARY OF EMBODIMENTS

According to a first aspect of the present disclosure, a character recognition apparatus is provided for processing an input image to recognize characters included in the input image. The character recognition apparatus is provided with: a computing circuit; and a memory that stores instructions being executable by the computing circuit. When executing the instructions, the computing circuit detects a plurality of character regions in the input image, each of the plurality of character regions including a character or a character string made of a plurality of characters. When executing the instructions, the computing circuit determines a direction of the character or the character string in each of the character regions. When executing the instructions, the computing circuit recognizes the character or the character string in each of the character regions. When executing the instructions, the computing circuit generates a connected region by connecting at least two character regions including the character(s) or the character string(s) having a same direction, the at least two character regions being close to each other at a distance less than a threshold. When executing the instructions, the computing circuit connects the character(s) or the character string(s) included in the connected region to each other.

According to a second aspect of the present disclosure, the character recognition apparatus of the first aspect is further configured as follows. When executing the instructions, the computing circuit generates extended regions by extending each of the character regions in a direction perpendicular to the direction of the character or the character string included in the character region. When executing the instructions, the computing circuit generates the connected region by connecting at least two character regions including the character(s) or the character string(s) having the same direction, the at least two character regions being close to each other at the distance less than the threshold, and the at least two character regions having the extended regions overlapping each other, respectively.

According to a third aspect of the present disclosure, the character recognition apparatus of the first or second aspect is further configured as follows. When executing the instructions, the computing circuit detects a first object region and a second object region in the input image, the first object region including a first object, and the second object region including a second object. When executing the instructions, the computing circuit detects a first character region or a first connected region included in the first object region, and detects a second character region or a second connected region included in the second object region. When executing the instructions, the computing circuit recognizes a first character or character string included in the first character region or the first connected region, and recognizes a second character or character string included in the second character region or the second connected region. When executing the instructions, the computing circuit compares the first character or character string with a third character or character string stored in advance in association with the first object, and compares the second character or character string with a fourth character or character string stored in advance in association with the second object.

According to a fourth aspect of the present disclosure, a character recognition method if provided for processing an input image to recognize characters included in the input image. The character recognition method includes detecting a plurality of character regions in the input image, each of the plurality of character regions including a character or a character string made of a plurality of characters. The character recognition method includes determining a direction of the character or the character string in each of the character regions. The character recognition method includes recognizing the character or the character string in each of the character regions. The character recognition method includes generating a connected region by connecting at least two character regions including the character(s) or the character string(s) having a same direction, the at least two character regions being close to each other at a distance less than a threshold. The character recognition method includes connecting the character(s) or the character string(s) included in the connected region to each other.

According to a fifth aspect of the present disclosure, the character recognition method of the fourth aspect is further configured as follows. The character recognition method includes detecting a first object region and a second object region in the input image, the first object region including a first object, and the second object region including a second object. The character recognition method includes detecting a first character region or a first connected region included in the first object region, and detecting a second character region or a second connected region included in the second object region. The character recognition method includes recognizing a first character or character string included in the first character region or the first connected region, and recognizing a second character or character string included in the second character region or the second connected region. The character recognition method includes comparing the first character or character string with a third character or character string stored in advance in association with the first object, and comparing the second character or character string with a fourth character or character string stored in advance in association with the second object.

According to a sixth aspect of the present disclosure, a program is provided, including instructions executed by a computing circuit implemented in a character recognition apparatus for processing an input image to recognize characters included in the input image. The instructions cause the computing circuit to execute detecting a plurality of character regions in the input image, each of the plurality of character regions including a character or a character string made of a plurality of characters. The instructions cause the computing circuit to execute determining a direction of the character or the character string in each of the character regions. The instructions cause the computing circuit to execute recognizing the character or the character string in each of the character regions. The instructions cause the computing circuit to execute generating a connected region by connecting at least two character regions including the character(s) or the character string(s) having a same direction, the at least two character regions being close to each other at a distance less than a threshold. The instructions cause the computing circuit to execute connecting the character(s) or the character string(s) included in the connected region to each other.

According to a seventh aspect of the present disclosure, the program of the sixth aspect is further configured as follows. The instructions cause the computing circuit to execute: detecting a first object region and a second object region in the input image, the first object region including a first object, and the second object region including a second object. The instructions cause the computing circuit to execute detecting a first character region or a first connected region included in the first object region, and detecting a second character region or a second connected region included in the second object region. The instructions cause the computing circuit to execute recognizing a first character or character string included in the first character region or the first connected region, and recognizing a second character or character string included in the second character region or the second connected region. The instructions cause the computing circuit to execute comparing the first character or character string with a third character or character string stored in advance in association with the first object, and comparing the second character or character string with a fourth character or character string stored in advance in association with the second object.

The character recognition apparatus, the character recognition method, and the program according to one aspect of the present disclosure are applicable to the recognition of a character string over multiple lines.

What is claimed is:

1. A character recognition apparatus for processing an input image to recognize characters included in the input image, the character recognition apparatus comprising:
a computing circuit; and
a memory that stores instructions being executable by the computing circuit,
wherein, when executing the instructions, the computing circuit:
detects a plurality of character regions in the input image, each of the plurality of character regions including a character or a character string made of a plurality of characters;
determines a direction of the character or the character string in each of the character regions;
recognizes the character or the character string in each of the character regions;
generates a connected region by connecting at least two character regions including the character(s) or the character string(s) having a same direction, the at least two character regions being close to each other at a distance less than a threshold; and
connects the character(s) or the character string(s) included in the connected region to each other, and
wherein, when executing the instructions, the computing circuit:
detects a first object region and a second object region in the input image, the first object region including a first object, and the second object region including a second object;
detects a first character region or a first connected region included in the first object region;
detects a second character region or a second connected region included in the second object region;
recognizes a first character or character string included in the first character region or the first connected region;
recognizes a second character or character string included in the second character region or the second connected region;
compares the first character or character string with a third character or character string stored in advance in association with the first object; and
compares the second character or character string with a fourth character or character string stored in advance in association with the second object.

2. The character recognition apparatus as claimed in claim 1, wherein, when executing the instructions, the computing circuit:
generates extended regions by extending each of the character regions in a direction perpendicular to the direction of the character or the character string included in the character region; and
generates the connected region by connecting at least two character regions including the character(s) or the character string(s) having the same direction, the at least two character regions being close to each other at the distance less than the threshold, and the at least two character regions having the extended regions overlapping each other, respectively.

3. A character recognition method for processing an input image to recognize characters included in the input image, the character recognition method including:
detecting a plurality of character regions in the input image, each of the plurality of character regions including a character or a character string made of a plurality of characters;
determining a direction of the character or the character string in each of the character regions;
recognizing the character or the character string in each of the character regions;
generating a connected region by connecting at least two character regions including the character(s) or the character string(s) having a same direction, the at least two character regions being close to each other at a distance less than a threshold; and
connecting the character(s) or the character string(s) included in the connected region to each other, and
wherein the character recognition method includes:
detecting a first object region and a second object region in the input image, the first object region including a first object, and the second object region including a second object;
detecting a first character region or a first connected region included in the first object region;
detecting a second character region or a second connected region included in the second object region;
recognizing a first character or character string included in the first character region or the first connected region;
recognizing a second character or character string included in the second character region or the second connected region;
comparing the first character or character string with a third character or character string stored in advance in association with the first object; and
comparing the second character or character string with a fourth character or character string stored in advance in association with the second object.

4. A program including instructions executed by a computing circuit implemented in a character recognition apparatus for processing an input image to recognize characters included in the input image, the instructions causing the computing circuit to execute:
detecting a plurality of character regions in the input image, each of the plurality of character regions including a character or a character string made of a plurality of characters;
determining a direction of the character or the character string in each of the character regions;
recognizing the character or the character string in each of the character regions;
generating a connected region by connecting at least two character regions including the character(s) or the character string(s) having a same direction, the at least two character regions being close to each other at a distance less than a threshold; and
connecting the character(s) or the character string(s) included in the connected region to each other, and
wherein the instructions cause the computing circuit to execute:
detecting a first object region and a second object region in the input image, the first object region including a first object, and the second object region including a second object;
detecting a first character region or a first connected region included in the first object region;
detecting a second character region or a second connected region included in the second object region;
recognizing a first character or character string included in the first character region or the first connected region;
recognizing a second character or character string included in the second character region or the second connected region;
comparing the first character or character string with a third character or character string stored in advance in association with the first object; and
comparing the second character or character string with a fourth character or character string stored in advance in association with the second object.
